(19) United States
(12) Patent Application Publication
(10) Pub. No.: US 2026/0065792 A1
(43) Pub. Date: Mar. 5, 2026

(54) SYSTEM AND METHOD FOR STRATEGIC AIRSPACE DECONFLICTION USING COOPERATIVE MULTI-AGENT REINFORCEMENT LEARNING

(71) Applicant: Richard Joseph Mitchell, TAVARES, FL (US)

(72) Inventor: Richard Joseph Mitchell, TAVARES, FL (US)

(21) Appl. No.: 19/383,639

(22) Filed: Nov. 8, 2025

(51) Int. Cl. G08G 5/80; G06N 3/092; G08G 5/26; G08G 5/57

(52) U.S. Cl. CPC G08G 5/80; G06N 3/092; G08G 5/26; G08G 5/57

(57) ABSTRACT

A system and method for strategic airspace deconfliction is disclosed, centered on a Cooperative Multi-Agent Platform (CMAP) embedded within an Automated Data Service Provider (ADSP) operating within a federated Unmanned Aircraft Systems (UAS) Traffic Management (UTM) network. The system's inventive feature resides in a specific technical architecture that synergistically integrates a real-time safety constraint into a strategic negotiation engine. A Regulatory Compliance Monitor (RCM) generates a real-time Conflict Risk Score that is incorporated directly into the Local Observation Vector of a Multi-Agent Reinforcement Learning (MARL) policy network. The MARL engine is thereby configured to select a strategic negotiation primitive (e.g., BID, YIELD, TRADE) that is dynamically determined based on this real-time Conflict Risk Score. This transforms abstract resource allocation into a safety-aware, risk-adaptive protocol, allowing an ADSP agent to maximize fleet efficiency while guaranteeing collective safe separation

### BACKGROUND OF THE INVENTION

### Technical Field

This invention resides in the technical fields of Artificial Intelligence (AI) and Multi-Agent Systems (MAS), specifically applying Deep Reinforcement Learning (DRL) techniques to highly regulated resource allocation problems.

The primary application domain is Aerospace/Aviation Technology, focusing on Unmanned Aircraft Systems (UAS) Traffic Management (UTM) and the methods for decentralized, strategic control of low-altitude airspace.

### Background Art

The evolution of UAS operations necessitates a sophisticated, scalable traffic management system. The Federal Aviation Administration (FAA) has introduced regulatory frameworks, such as the proposed Part 108, aimed at establishing rules for large-scale Beyond Visual Line of Sight (BVLOS) operations. This framework relies heavily on the concept of ADSPs (Automated Data Service Providers) and the USS Network (Unmanned Service Suppliers) to manage operational intents. A critical function of the ADSP is conformance monitoring, which involves tracking a UAS's adherence to its planned flight route and notifying other airspace users if deviation occurs, enabling collision risk mitigation.

### Traditional Deconfliction (Rule-Based):

Previous approaches to air traffic management and UAS collision avoidance have traditionally relied on fixed, predefined protocols. These protocols typically mandate specific actions or messages that must be broadcast based on an aircraft's current location, circumstances, and proximity to other aircraft. Such systems operate on rigid rules that dictate mandatory evasive maneuvers or pre-defined flight corridors. While guaranteeing minimum safety floors, these prescriptive, rule-based systems are inherently limited in their ability to maximize airspace utilization or respond optimally to complex, dynamic scenarios involving multiple competing objectives. Their rigidity prevents the strategic adaptation necessary for dense urban airspace.

### Path Optimization (Single-Agent):

Related prior art focuses on optimizing flight paths for individual aircraft. These methods involve generating a plurality of waypoints and calculating unique trajectories based on allowable parameters (heading, altitude, speed). The goal is often to identify a trajectory that minimizes time or maximizes efficiency metrics for a single aircraft. These approaches treat other airspace occupants (and their associated operational intents) as fixed, passive constraints that must be avoided. They are effective at maximizing efficiency within a given, defined airspace volume but entirely lack the capacity to negotiate changes to the constraints themselves. They cannot strategically bid for, trade, or yield portions of the airspace volume occupied by others to achieve a superior outcome.

### Limitation Synthesis (the Inventive Gap):

The transition to a federated UTM model, where multiple USSs (ADSPs) exchange information and negotiate on behalf of their subscribed operators, demands a new paradigm for deconfliction. The existing prior art fails to provide a scalable, adaptive solution for this decentralized regulatory environment. The primary limitation is the absence of a system capable of learning strategic negotiation policies-specifically, how to dynamically bargain for, or yield, operational intents. Operational intents are, in essence, 4D volumes of negotiable airspace resource. By modeling this process as a multi-player game, the CMAP system fills the gap by enabling ADSP agents to generate complex, cooperative behaviors necessary to navigate dense airspace far more effectively than any human-managed or simple rule-based system could.

### BRIEF SUMMARY OF THE INVENTION

The Cooperative Multi-Agent Platform (CMAP) provides a system and method for strategic, dynamic airspace deconfliction by embedding a Multi-Agent Reinforcement Learning (MARL) engine within the software agent of an ADSP.

The core inventive concept resides in the specific technical architecture that synergistically integrates a real-time safety compliance module with a strategic negotiation engine. The system transforms abstract economic bargaining into a safety-aware, risk-adaptive protocol by directly incorporating a real-time Conflict Risk Score, generated by a Regulatory Compliance Monitor (RCM), into the state observation vector of the MARL policy network.

This direct technical linkage enables the MARL agent to learn complex negotiation strategies that are intrinsically tied to, and dynamically weighted by, the immediate safety and conformance status of the agent's fleet. Instead of relying on simple rule-based avoidance, the CMAP agent learns when and how to engage in strategic negotiations—such as generating a utility—based bid for a contested volume or strategically yielding airspace to a peer agent-based on a learned policy that balances safety, efficiency, and negotiation history.

The technical advantage of this invention is a system that dynamically allocates airspace resources based on both economic utility and real-time safety-critical data, thereby maximizing the throughput and utilization of the National Airspace System (NAS) capacity beyond what static scheduling or simple rule-based systems can achieve.

The system comprises key components: the MARL Engine, which executes the learned negotiation policy; the Intent Negotiation Module (INM), which handles communication translation; and the Regulatory Compliance Monitor (RCM), which provides the safety-critical data feed that enables the risk-adaptive negotiation policy.

### BRIEF DESCRIPTION OF THE SEVERAL VIEWS OF THE DRAWING

FIG. 1 illustrates the Federated UTM Architecture, depicting multiple ADSP/USS nodes, each hosting a CMAP instance interconnected through the centralized Discovery and Synchronization Service (DSS) (120).

FIG. 2 is a Cooperative Multi-Agent Platform (CMAP) Internal Schematic, illustrating the closed-loop control system and the critical data flow from the Regulatory Compliance Monitor (RCM) (220) to the State Observation (230), which serves as input to the MARL Engine (240).

FIG. 3 is a Flowchart of the Strategic Negotiation and Deconfliction Process, detailing the sequence of operations from conflict identification (300) to the selection of a negotiation action (Aₜ) (310) and subsequent intent modification (360).

FIG. 4 illustrates the Centralized Training (470), Decentralized Execution (480) (CTDE) Architecture, showing how a centralized component (Critic) (410) guides the learning of individual, decentralized policy networks (Actors) (450).

### DETAILED DESCRIPTION OF THE INVENTION

The following detailed description provides enabling structure for the method and system of strategic airspace deconfliction using a Cooperative Multi-Agent Platform (CMAP).

### The Cooperative Multi-Agent Platform (CMAP) Architecture

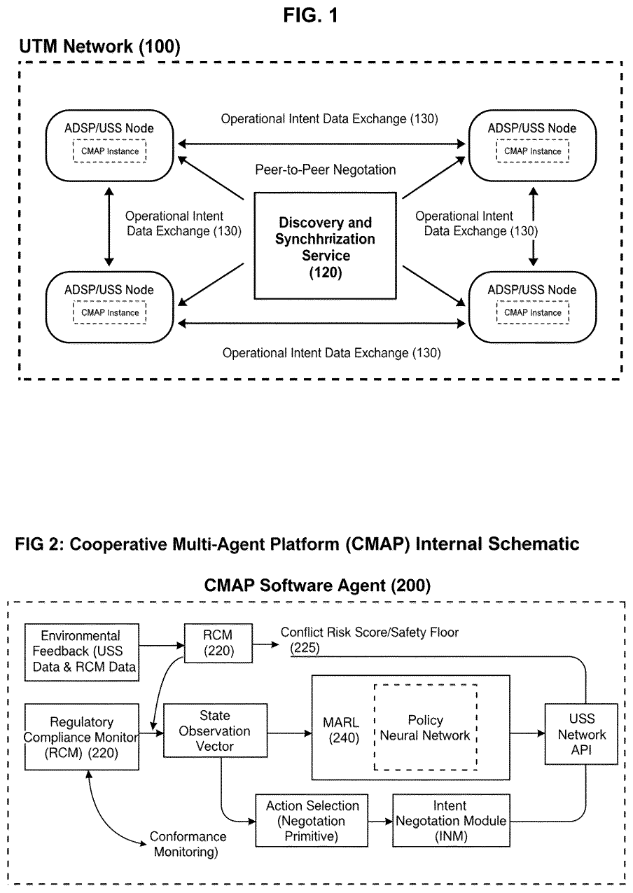

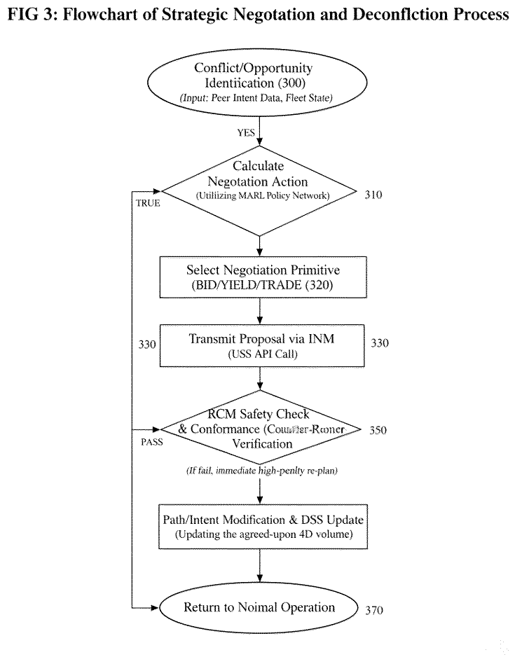

Referring generally to FIG. 1 and FIG. 2, the CMAP (115) is a specialized software layer operating within the infrastructure of an FAA-approved Automated Data Service Provider (ADSP) (110). Each CMAP instance, acting as an Agent, serves as the strategic decision-making control authority for its associated fleet of UAS.

### Agent Status and Interface:

The CMAP software agent interfaces directly with the wider USS Network via industry-standard APIs (FIG. 2, 270). The Discovery and Synchronization Service (DSS) (120) is central to this operation, enabling different USS/ADSPs to discover each other and synchronize their operational intent data (130). The CMAP is configured to process this synchronized intent data, translating these regulatory resources into actionable state observations (230) for the MARL engine (240).

### Intent Negotiation Module (INM) Functions:

The Intent Negotiation Module (INM) (260) serves as the communication gateway and translation layer for the CMAP. Its primary responsibility is the syntactic and semantic conversion of the MARL Engine's abstract strategic decisions (250) (e.g., “BID on volume V_{new}”) into the specific data exchange formats required by the USS Network for intent exchange, proposal, and synchronization.

### Regulatory Compliance Monitor (RCM) Functions:

The Regulatory Compliance Monitor (RCM) (220) is a safety-critical component. It maintains hard, non-negotiable constraints on flight operations, continuously performing conformance monitoring (222) to track the fleet's adherence to its currently agreed-upon operational intent. The RCM provides two essential functions that enable the core invention:
1. A real-time “Conflict Risk Score” (225) which is incorporated directly into the MARL state observation (230), as shown in FIG. 2. For example, said Conflict Risk Score (S_{Risk}) may be calculated as a function of the minimum Time-to-Collision (TTCₘᵢₙ) and Time-to-Conformance-Deviation (TCDₘᵢₙ) for all vehicles in the agent's fleet, e.g., S_{Risk}=1/min(TT_{Cmin}, TCDₘᵢₙ).
2. A critical penalty signal, which forms the negative safety component (R_{safety}) of the MARL reward function during training, and a final safety check on negotiated actions before execution.

### Operation in the Federated UTM Environment

### Operational Intent as Resource Allocation:

The invention models the UTM environment as a decentralized resource allocation problem. The resource being allocated is the 4D airspace volume defined by the operational intent (geometric constraints plus time windows). By framing air traffic management as a risk-adaptive negotiation challenge, the system achieves a fundamental capability shift.

### Multi-Agent Reinforcement Learning (MARL) Formulation

The system's novelty is derived from its explicit formulation as a Multi-Agent Markov Decision Process (MAMDP) tailored for safety-aware regulatory negotiation.

### State Space (Local Observation Vector

$${O}_{t}^{n}$$

): Since execution is decentralized, each Agent n relies on a Local Observation Vector

$$( {O}_{t}^{n} ) .$$

This vector includes sufficient detail to allow for complex decision-making. The inclusion of the real-time “Conflict Risk Score” as a direct input vector is a critical technical feature, distinguishing the system from conventional economic models and simple kinetic avoidance systems. The vector comprises:
Current Kinematic Data: Position, velocity, acceleration, and planned future trajectory for all UAS in Agent n's fleet.
Peer Intent Projection: Geometric and temporal projections (4D volume definition, time windows) of all known neighboring operational intents, as synchronized via the DSS.
Conflict Risk Score: Real-time metrics derived from the RCM (225), quantifying the time-to-collision or time-to-conformance deviation for the highest-risk vehicle in the fleet.
Negotiation Context: Current market state and negotiation history, including the number of open bids and the success rate with specific peer agents.

### Action Space (Aₜ): The Negotiation Primitives

The Action Space of the CMAP agent is defined entirely by a set of discrete, strategic negotiation primitives that trigger data exchanges via the INM, not kinetic maneuvers.

TABLE 1
Action Space Taxonomy for Strategic Intent Negotiation

| Negotiation Action | | |
|---|---|---|
| (Aₜ) | Type | Description |
| BID (V_{new}, P_{bid}) | Acquisition/Competitive | Agent n attempts to acquire a new, |
| | | contested intent volume (V_{new}) by |
| | | attaching an internally calculated, |
| | | non-monetary utility score (P_{bid}). The |
| | | utility score is learned by the policy |
| | | network based on predicted return on |
| | | investment. |
| YIELD (V_{old}, | Cooperative/Yielding | Agent n voluntarily relinquishes all or |
| Recipient m) | | part of its current volume (V_{old}) to a |
| | | specific peer Agent m. This is a |
| | | learned reciprocal policy for |
| | | maximizing long-term fleet utility. |
| PROPOSE TRADE | Cooperative/Trade | Agent n proposes an exchange of |
| (Vₒᵤₜ ↔ Vᵢₙ) | | non-contiguous intent volumes with |
| | | Agent m, targeting a mutually |
| | | beneficial redistribution. |
| PROPOSE | Self-Optimization | Agent n requests minor, non- |
| MODIFICATION (T, | | conflicting alterations to its own |
| H, A) | | operational intent. |
| ACCEPT/REJECT | Response | Agent n evaluates the merit of an |
| (Proposal P) | | incoming negotiation proposal (P) |
| | | based on its policy value. |

### Exemplary Embodiment of the Composite Reward Function (Rₜ)

To train a robust and safe strategic policy, the Reward Function (Re) must be composite. The following provides a specific, non-limiting exemplary embodiment of the Composite Reward Function required to enable a Person of Ordinary Skill in the Art (POSITA) to practice the invention.

A POSITA can implement the invention using a composite function, such as a weighted sum:

$${R}_{t} = ( {w}_{safety} \cdot {R}_{Safety} ) + ( {w}_{efficiency} \cdot {R}_{Efficiency} ) + ( {w}_{negotiation} \cdot {R}_{Negotiation} )$$

Where W_{safety}, W_{efficiency}, and W_{negotiation} are scalar weighting factors (e.g., W_{safety}=1.0, W_{efficiency}=0.2, W_{negotiation}=0.1) used to balance the competing objectives, and the components are defined as follows:
1. Safety Component (R_{safety}): This component acts as a hard constraint or a large negative penalty to ensure regulatory conformance. It is defined as:

$${R}_{Safety} = - {C}_{penalty} ( e . g . , - 1000 ) if {S}_{Risk} > {S}_{threshold}$$

$${R}_{Safety} = 0 if {S}_{Risk} \leq {S}_{threshold}$$

Where C_{penalty} is a large negative constant, S_{Risk} is the real-time Conflict Risk Score provided by the RCM, and S_{threshold} is a predefined safety margin. This term heavily penalizes any policy that results in a non-conformant or unsafe state.
2. Efficiency Component (R_{Efficiency}): This component rewards mission completion and resource optimization. For example:

$${R}_{Efficiency} = {C}_{complete} - ( {C}_{time} \cdot {T}_{flight} ) - ( {C}_{energy} \cdot {E}_{consumed} )$$

Where C_{complete} is a large positive reward for mission completion (e.g., +500), T_{flight} is total flight time in seconds, Cₜᵢₘₑ is a small negative penalty per time step (e.g., −0.1), and C_{energy} is a penalty proportional to energy consumed.
3. Negotiation Component (R_{Negotiation}): This component rewards successful and efficient bargaining behavior. For example:
   R_{Negotiation}+C_{accept} (e.g., +20) for each ‘ACCEPT’ received for a ‘PROPOSE TRADE’ or ‘BID’ initiated by the agent.
   R_{Negotiation}=−C_{reject} (e.g., −5) for each ‘REJECT’ received for a ‘BID’ initiated by the agent.
   R_{Negotiation}=−C_{delay} (e.g., −1) for each time step a conflict remains unresolved.

This mathematical formulation enables the MARL algorithm to learn a policy that prioritizes safety (avoiding the large R_{safety} penalty) while seeking to maximize efficiency and negotiation success.

### MARL Algorithms and Training Details

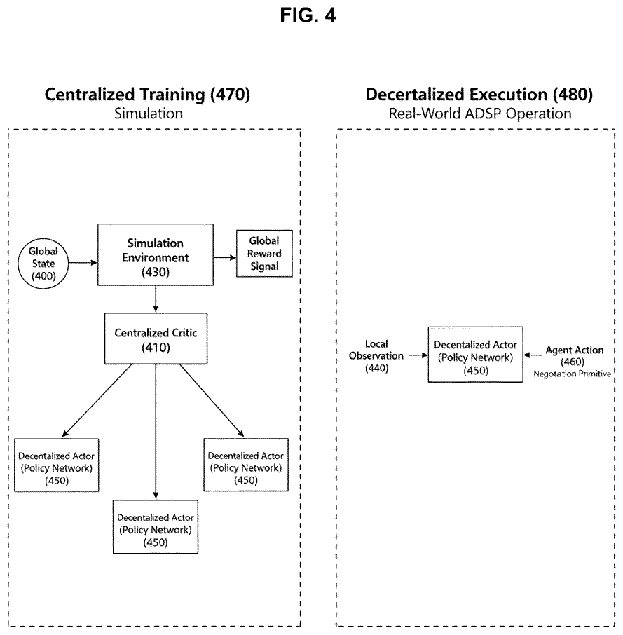

Training of the MARL policy network requires a dedicated, high-fidelity simulation environment. Since agents execute actions independently based on local observations, but the global outcome (safety) is shared, a Centralized Training, Decentralized Execution (CTDE) framework is mandated, as illustrated in FIG. 4.

TABLE 2
Key MARL Algorithms for Cooperative Deconfliction

| | Example | |
|---|---|---|
| Algorithm Class | Algorithm(s) | Primary Use Case in CMAP |
| Value | QMIX, VDN | Centralized Training, Cooperative |
| Decomposition | | Optimization. Guarantees consistency |
| (VD) | | between individual decentralized agent |
| | | policies and the global safety/efficiency |
| | | optimum. |
| Policy Gradient | MAPPO (Multi- | Robust Policy Learning, Complex Action |
| | Agent Proximal | Space Handling. Provides stable |
| | Policy Optimization) | convergence when learning over the |
| | | strategic negotiation action set. |

### Guaranteeing Safe Separation

Safety acts as a hard constraint. During policy execution (FIG. 2), the final output of the MARL engine (240) (the selected negotiation primitive) is routed through the Regulatory Compliance Monitor (RCM) (220). The RCM performs a critical safety check to verify that the resulting path, subsequent to the negotiation, maintains all minimum guaranteed separation standards, regardless of the learned efficiency gain. This safety override mechanism ensures regulatory compliance and integrity of the system.

What is claimed is:

1. A method for safety-adaptive strategic deconfliction in a federated Unmanned Aircraft Systems Traffic Management (UTM) network, the method comprising the steps of:
a. receiving, by a processor of an Automated Data Service Provider (ADSP) agent from an associated Regulatory Compliance Monitor (RCM), a real-time Conflict Risk Score quantifying a risk of non-conformance for a fleet of Unmanned Aircraft Systems (UAS);
b. generating, by the processor, a Local Observation Vector, wherein said Local Observation Vector comprises said real-time Conflict Risk Score and a historical negotiation context;
c. inputting, by the processor, said Local Observation Vector into a trained Multi-Agent Reinforcement Learning (MARL) policy network;
d. selecting, by the MARL policy network, a strategic negotiation primitive from a predefined action space, wherein said action space comprises at least a ‘BID’ primitive and a ‘YIELD’ primitive, and wherein said selection is dynamically determined based at least in part on said real-time Conflict Risk Score; and
e. transmitting, by an Intent Negotiation Module (INM), the selected strategic negotiation primitive to a peer ADSP agent via a USS Network Application Programming Interface (API) to dynamically resolve a potential conflict.

2. The method of claim 1, wherein the predefined action space further comprises a ‘PROPOSE TRADE’ primitive, a ‘PROPOSE MODIFICATION’ primitive, and an ‘ACCEPT/REJECT’ primitive.

3. The method of claim 1, wherein the MARL policy network was trained using a composite reward function, said composite reward function comprising:
a. a negative safety component (R_{safety}) applied as a penalty when said Conflict Risk Score exceeds a predefined threshold;
b. a positive efficiency component (R_{Efficiency}) based on minimizing fleet flight time; and
c. a positive negotiation component (R_{Negotiation}) based on successful outcomes of said negotiation primitives.

4. A Cooperative Multi-Agent Platform (CMAP) system for safety-adaptive strategic deconfliction, configured for deployment within an Automated Data Service Provider (ADSP) infrastructure, the system comprising:
a. a Regulatory Compliance Monitor (RCM) module configured to:
i. perform real-time conformance monitoring for a fleet of Unmanned Aircraft Systems (UAS), and
ii. calculate a real-time Conflict Risk Score based on said conformance monitoring;
b. a processor; and
c. a non-transitory memory storing a trained Multi-Agent Reinforcement Learning (MARL) policy network and executable instructions that, when executed by the processor, configure the processor to function as a MARL Engine, said MARL Engine configured to:
i. receive said real-time Conflict Risk Score from the RCM;
ii. generate a Local Observation Vector comprising said real-time Conflict Risk Score and a historical negotiation context;
iii. select a strategic negotiation primitive from a predefined action space by inputting said Local Observation Vector into said trained MARL policy network, wherein the selected primitive is dynamically determined based at least in part on said real-time Conflict Risk Score; and
d. an Intent Negotiation Module (INM) configured to transmit the selected strategic negotiation primitive to a peer ADSP agent.

5. The system of claim 4, wherein the MARL policy network was trained utilizing a Centralized Training, Decentralized Execution (CTDE) architecture and a value decomposition algorithm, said algorithm being one of a Value Decomposition Network (VDN) or a QMIX algorithm.

6. A non-transitory computer-readable medium storing executable instructions that, when executed by a processor of an Automated Data Service Provider (ADSP) operating in a Unmanned Aircraft Systems Traffic Management (UTM) network, cause the processor to perform the steps of:
a. receiving, from an associated Regulatory Compliance Monitor (RCM), a real-time Conflict Risk Score quantifying a risk of non-conformance;
b. generating a Local Observation Vector, wherein said Local Observation Vector comprises said real-time Conflict Risk Score and a historical negotiation context;
c. inputting said Local Observation Vector into a trained Multi-Agent Reinforcement Learning (MARL) policy network;
d. selecting, by the MARL policy network, a strategic negotiation primitive from a predefined action space, wherein said selection is dynamically determined based at least in part on said real-time Conflict Risk Score; and
e. transmitting the selected strategic negotiation primitive to a peer ADSP agent via an Intent Negotiation Module (INM).
